(19) United States
(12) Patent Application Publication
(10) Pub. No.: US 2017/0235412 A1
(43) Pub. Date: Aug. 17, 2017

(54) ELECTRONIC APPARATUS WITH USER INPUT SWITCHABLE BETWEEN BUTTON AND TOUCH TYPES, AND METHOD OF CONTROLLING THE SAME

(71) Applicant: SAMSUNG ELECTRONICS CO., LTD., Suwon-si (KR)

(72) Inventor: Jae-eun CHEONG, Yangju-si (KR)

(73) Assignee: SAMSUNG ELECTRONICS CO., LTD., Suwon-si (KR)

(21) Appl. No.: 15/432,027

(22) Filed: Feb. 14, 2017

(30) Foreign Application Priority Data
Feb. 16, 2016 (KR) 10-2016-0018005

(51) Int. Cl. G06F 3/041; G06F 3/033

(52) U.S. Cl. CPC G06F 3/0416; G06F 3/033

(57) ABSTRACT

Disclosed is an electronic apparatus that includes a button input receiver including a button for receiving a user button input; a touch sensor unit configured to sense a user touch input to the button. The electronic apparatus also includes a controller configured to execute a first function corresponding to the button among a plurality of functions provided by the electronic apparatus if the user button input is received with regard to the button, and, if the user touch input is sensed with regard to the button, determine a second function among the plurality of functions based on a method of the user touch input and execute the determined second function.

### CROSS-REFERENCE TO RELATED THE APPLICATION

The application claims priority from Korean Patent Application No. 10-2016-0018005 filed on Feb. 16, 2016 in the Korean Intellectual Property Office, the disclosure of which is incorporated herein by reference.

### BACKGROUND

1. Field

Apparatuses and methods consistent with the exemplary embodiments relate to an electronic apparatus with a user input switchable between a button type and a touch type, and a method of controlling the same.

2. Description of the Related Art

A user controls an electronic apparatus through a user input. The user selects a desired function among various functions provided by the electronic apparatus so as to control the electronic apparatus according to his/her intention, in which such selection of the function is achieved through the user input. Further, the electronic apparatus often supports a remote control as an input unit so that a user can easily input an instruction even though he/she is distant from the electronic apparatus.

Among the electronic apparatuses, the display apparatus has much interaction with a user. As an example of the display apparatus, a television (TV) receives a user's many inputs such as channel selection, volume control, etc. Therefore, the remote control is very important as an input unit for the TV, and a user is highly dependent on the remote control.

Most of the remote controls include a lot of buttons to execute various functions provided by the TV when each of them is pressed once. In other words, the buttons of the remote control are in one-to-one correspondence with the functions provided by the TV, and thus the number of buttons in the remote control increases as much as the number of functions provided by the TV.

However, a recent trend shows that the number of buttons in the remote control is decreasing. The reason is because functions are too many to be put in one remote control as development of a smart TV or the like increases the number of functions provided by the TV and emphasizes the interaction with a user more, and thus a user tends toward using a screen in selecting a desired function. Specifically, a method of inputting a user's instruction has morphed into a method of displaying information on the screen about the functions provided by the TV and a user selecting one among the functions displayed on the screen by an arrow button or the like in the remote control. As a result, a remote control has recently been released with fewer buttons. Such a remote control is illustrated in FIG. 1. FIG. 1 shows an example of a recently released remote control.

If the number of buttons is decreased in the remote control, it is beneficial in that the remote control has a small form factor and enables a user to make an input more straightforward than before. However, the downside is that a frequently used function is not easily accessible. In particular, this is especially inconvenient for a person who may have difficulty obtaining information through a screen, for example, a person who is visually impaired or an elderly with poor vision.

To solve these problems, there have been efforts. As one of the related arts, a menu of “accessibility shortcut,’ where major functions needed for a visually impaired person to use the TV are collected, is executed when a mute key 101 arranged at a lateral side of a remote control 100 is pressed and held.

However, the menu of “accessibility shortcut” is not enough to meet the needs of a visually impaired person who is enjoying the TV. Further, there is a limit to sub menus involved in the accessibility shortcut menu, and therefore a visually impaired person has to find a desired menu while listening to voice guides one by one or get someone's help in order to use another function provided by the TV.

### SUMMARY

According to exemplary embodiments, a plurality of functions are assigned to each of buttons that constitute a user input of an electronic apparatus, and every button includes a touch sensor portion so that a user can select one among many functions by controlling only one button through a button input and a touch input. Further, a user can manually set each button with a corresponding function. Accordingly, it is more convenient for a user to control the electronic apparatus having fewer buttons as the user input.

The above and/or the aspects will become apparent and more readily appreciated from the following description of exemplary embodiments. Further, it will be understood that the above and/or the aspects may be realized by means disclosed in appended claims and combination thereof.

According to an aspect of an exemplary embodiment, there is provided an electronic apparatus including: a button input receiver that includes a button for receiving a user button input; a touch sensor configured to sense a user touch input to the button; and a controller configured to execute a first function corresponding to the button among a plurality of functions provided by the electronic apparatus if the user button input is received with regard to the button The controller is also configured to, if the user touch input is sensed with regard to the button, determine a second function among the plurality of functions based on a method of the user touch input and execute the determined second function.

The electronic apparatus may include a remote control that includes the button input receiver, the touch sensor, and a transmitter for remotely transmitting a signal corresponding to the user button input or the user touch input. The electronic apparatus may also include a receiver configured to receive the signal from the transmitter.

The controller may set a method of the user touch input with regard to the button, and a function corresponding to the method in accordance with a user setting input.

According to exemplary embodiments, a user may manually sets his/her desired function so that frequently used functions can be executed by a single input, thereby making the electronic apparatus more convenient for the user. Further, when the user is allowed to manually set not only the function to be executed corresponding to the touch input method but also the touch input method for executing the function, it is possible to provide an input method more intuitive for the user and it is thus possible to give greater convenience and satisfaction to the user with regard to the user interface.

The controller may determine whether to set a function to the button based on a duration of the user touch input.

The controller may determine whether to set a function to the button based on a number of successive touches of the user touch input.

The electronic apparatus may include a storage configured to store information about the function set to the button and the method of the user touch input corresponding to the function.

The electronic apparatus may include a communicator configured to communicate with an external device, and the controller may receive information about the function set to the button and the method of the user touch input corresponding to the function from the external device through the communicator.

In this case, a user can control the electronic apparatus based on the settings as desired by him/her at anytime and anywhere.

The controller may determine the first function based on the method of the user button input and execute the determined first function.

According to an aspect of an exemplary embodiment, there is provided a control method of an electronic apparatus. The control method may include: executing a first function corresponding to a button among a plurality of functions provided by the electronic apparatus if a user button input is received with regard to the button; and, if the user touch input is sensed with regard to the button, determining a second function among the plurality of functions based on a method of the user touch input, and executing the determined second function.

The control method may further include transmitting, from a remote control device to the electronic apparatus, a signal corresponding to the user button input or the user touch input with regard to the button.

The control method may further include setting a method of the user touch input with regard to the button, and a function corresponding to the method in accordance with a user setting input.

In this manner, a user may manually set his/her desired function so that frequently used functions can be executed by a single input, thereby making the electronic apparatus more convenient for the user. Further, if the user is allowed to manually set not only the function to be executed corresponding to the touch input method but also the touch input method for executing the function, it is possible to provide an input method more intuitive for the user and it is thus possible to provide greater convenience and satisfaction to the user with regard to the user interface.

The control method may further include determining whether to set a function to the button based on a duration of the user touch input.

The control method may further include determining whether to set a function to the button based on a number of successive touches of the user touch input.

The control method may further include storing information about the function set to the button and the method of the user touch input corresponding to the function.

The control method may further include receiving information about the function set to the button and the method of the user touch input corresponding to the function from an external device.

In this case, a user can control the electronic apparatus based on the settings as desired by him/her at anytime and anywhere.

The control method may further include determining the first function based on the method of the user button input, and executing the determined first function.

### BRIEF DESCRIPTION OF THE DRAWINGS

The above and/or the aspects will become apparent and more readily appreciated from the following description of exemplary embodiments, taken in conjunction with the accompanying drawings, in which:

FIG. 1 shows an example of a remote control released recently;

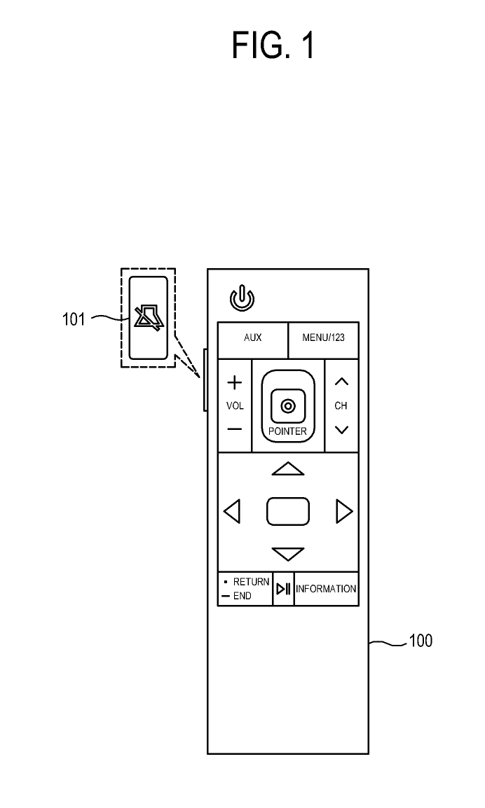

FIG. 2 shows that an electronic apparatus 200 according to an exemplary embodiment includes a remote control 202 as an input unit separate from a display area 201;

FIG. 3 is a block diagram of the electronic apparatus 200 with the remote control 202 according to an exemplary embodiment;

FIG. 4 is a block diagram of an electronic apparatus without a remote control according to an exemplary embodiment;

FIG. 5 is a flowchart of operating an electronic apparatus according to an exemplary embodiment;

FIG. 6 is a flowchart of operating an electronic apparatus according to an exemplary embodiment, in which a function setting instruction and a function selecting instruction are determined based on a duration of a touch input;

FIG. 7 shows an example of a user's touch input for issuing a function executing instruction according to an exemplary embodiment where the function executing instruction and a function setting instruction are determined based on a lasting time of a touch input; and

FIG. 8 shows an example of a user's touch input for issuing the function setting instruction according to an exemplary embodiment where the function executing instruction and the function setting instruction are determined based on a lasting time of a touch input.

### DETAILED DESCRIPTION OF EXEMPLARY EMBODIMENTS

Below, exemplary embodiments will be described in more detail with reference to accompanying drawings. At this time, the structures and functions illustrated in and described together with the drawings are just given as an exemplary embodiment and not construed to limit the present inventive concept and the key structures and functions. In the following descriptions, detailed descriptions about publicly known functions or elements may be omitted in the following description and accompanying drawings if it is determined that they interfere with the presentation of this disclosure.

Terms to be used in the following descriptions will be selected as general terms currently used as widely as possible taking functions of elements into account, but may be varied depending on intent of those skilled in the art, precedents, the advent of new technology, etc. In particular, there may be a term voluntarily selected by the applicant. In this case, the meaning of the term will be explained in detail through the relevant detailed descriptions. Therefore, the terms set forth herein have to be read in light of its meaning and content throughout the following descriptions rather than naming.

In the following exemplary embodiments, terms including ordinal numbers such as first, second and the like are employed for representing a variety of elements without limiting the elements to the terms. These terms are just used for distinguishing between one element and another element. For example, a first element may be named a second element, and vice versa as long as it does not depart from the scope of the present disclosure.

In the following exemplary embodiments, a singular expression may involve a plural expression as long as it does not clearly give different meaning contextually.

In the following descriptions, terms such as “comprise,” “include” or “have” refer to presence of features, numbers, steps, operations, elements, components or combination thereof, and do not exclude presence or addition of one or more other features, numbers, steps, operations, elements, components or combination thereof.

In the following exemplary embodiments, a “module” or a “portion” may perform at least one function or operation, and be achieved by hardware or software or combination of hardware and software. Further, a plurality of “modules” or a plurality of “portions” may be modularized into at least one processor except a “module” or “portion” required to be achieved by a specific hardware component.

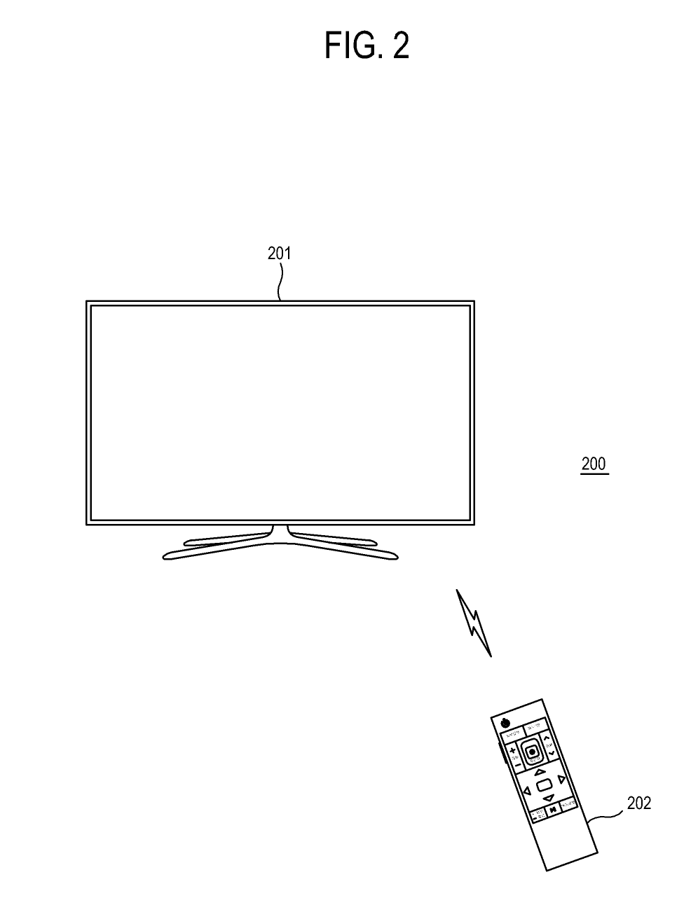

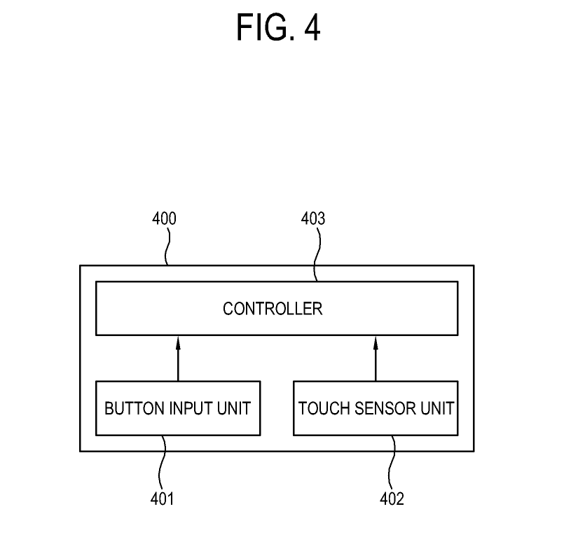

FIG. 2 shows that an electronic apparatus 200 according to an exemplary embodiment includes a remote control 202 as an input unit separate from a display area 201. If the electronic apparatus is a television (TV), it is likely to include the remote control 202 as shown in FIG. 2. However, the electronic apparatus according to an exemplary embodiment is not limited to a display apparatus or a TV, but includes any apparatus capable of processing an electronic signal. According to an exemplary embodiment, the remote control 202 is not essential. Although the electronic apparatus 200 according to an exemplary embodiment is a TV, a button input unit 401 and a touch sensor unit 402, as shown in FIG. 4, do not have to be separated from the TV in the form of a remote control as the one shown in FIG. 2.

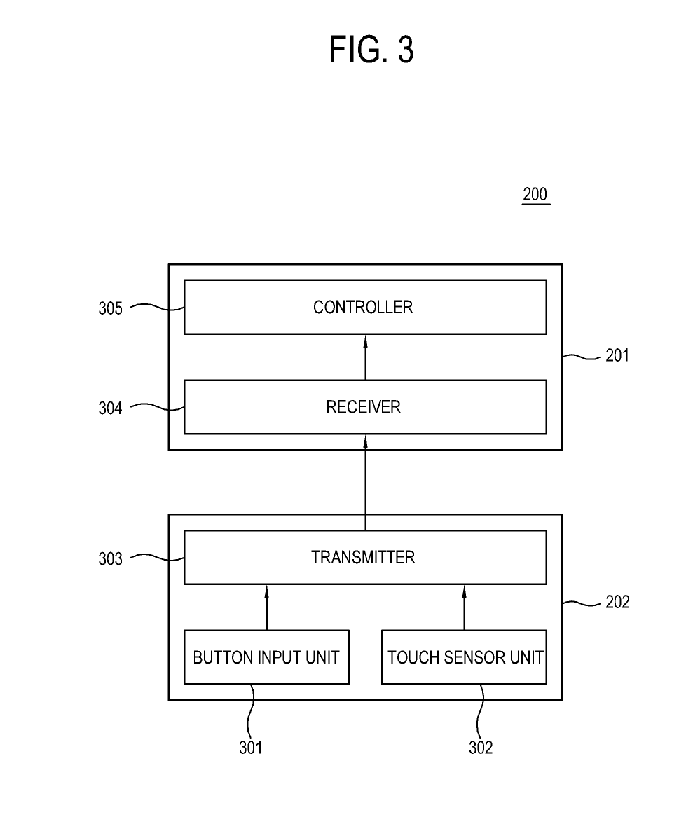

FIG. 3 is a block diagram of the electronic apparatus 200 with the remote control 202 according to an exemplary embodiment. The remote control 202 includes a button input unit 301, a touch sensor unit 302 and a transmitter 303.

The button input unit 301 includes a button for receiving a user's button input. There may be one or more buttons. If a user presses the button, the button input unit 301 recognizes this button press. There may be various types of button presses recognizable by the button input portion. For example, the button may be pressed once, pressed twice, pressed and held, and so on. However, there are no limits to a button input method recognizable by the button input unit 301.

The touch sensor unit 302 senses a user's touch input to the button. A touch sensing method includes a resistive method, a capacitive method, an infrared method, an ultrasonic method, etc., but not limited thereto. A user may make various touch inputs sensible by the touch sensor portion. For example, the touch input method recognizable by the touch sensor portion may include a single tap, double taps, tapping and holding, sliding in a specific direction, multi-touch, etc., but not limited thereto.

The transmitter 303 sends a receiver 304 a signal about a user's instruction input through the button input unit 301 or the touch sensor unit 302. A method of sending the signal includes wireless communication using an infrared or radio frequency (RF) signal, Zigbee, Bluetooth, etc. but not limited thereto as long as it can transmit a signal. The signal transmitting method may be achieved by wired communication.

The receiver 304 receives a signal from the transmitter 303 and transfers it to a controller 305.

The controller 305 executes a first function corresponding to the button among a plurality of functions provided by the display apparatus when a user's button input is received with regard to the button, and determines a second function among the plurality of functions based on a user's touch input methods if a user's touch input is sensed in the button and executes the determined second function. The controller may include a central processing unit (CPU) if the electronic apparatus according to an exemplary embodiment is a computer, or an application program (AP) if the electronic apparatus is a mobile device. The operations of the controller may be achieved by hardware, software or both.

FIG. 4 is a block diagram of an electronic apparatus without a remote control according to an exemplary embodiment. As mentioned above, the remote control 202 may not be an essential part of the electronic apparatus according to an exemplary embodiment. In this case, the transmitter 303 and the receiver 304 are excluded from the electronic apparatus of FIG. 3. That is, the electronic apparatus includes the button input unit 401, the touch sensor unit 402 and the controller 403. The button input unit 401, the touch sensor unit 402 and the controller 403 of this exemplary embodiment may be equivalent to the button input unit 301, the touch sensor unit 302 and the controller 305 of the previous exemplary embodiment.

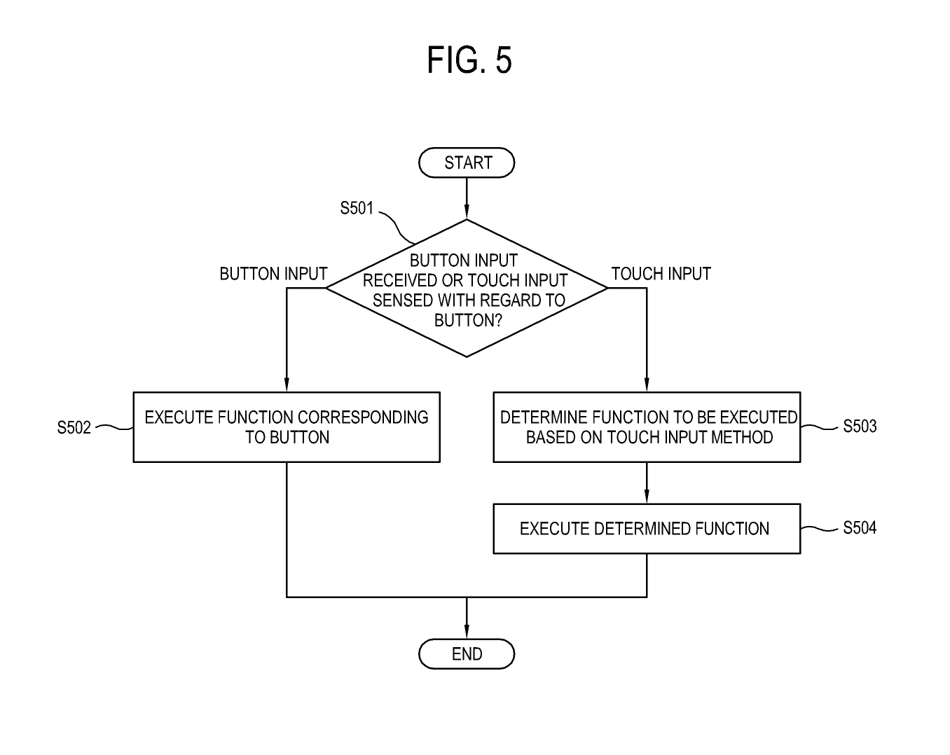

FIG. 5 is a flowchart of operating an electronic apparatus according to an exemplary embodiment. The button input unit 401 and the touch sensor unit 402 respectively sense a user's button input and touch input (S501). If a user's button input is sensed, the controller 403 controls the first function corresponding to the button among the plurality of functions provided by the display apparatus (S502). If a user's touch input is sensed, the controller 403 determines the second function among the plurality of functions based on the sensed touch input methods (S503) and executes the determined second function (S504).

For example, if a user presses a power button under conditions that it is set to execute a power on/off function when the power button of the remote control is pressed, a voice guide function when the power button is tapped once, and a descriptive video service function when the power button is tapped twice, the button input unit 401 senses the press and transmits a signal corresponding to a power-button press input to the controller 403, and the controller determines that a function corresponding to the power button is the power on/off function and controls the display apparatus to execute the power on/off function. If a user touches the power button, the touch sensor unit 402 senses the touch and transmits a signal corresponding to a power-button touch input to the controller 403, and the controller 403 determines a touch input method. If the touch input method is the “single tap” of the power button, the controller 403 determines that the “voice guide” function corresponds to the single tap and controls the display apparatus to execute the voice guide function. If the touch input method is the “double taps” of the power button, the controller 403 determines that the “descriptive video service” function corresponds to the double taps and controls the display apparatus to execute the descriptive video service function.

The foregoing examples are related to the cases where the functions are previously set to be respectively executed when a user touches the button by corresponding touch input methods. Alternatively, a user may manually set a function to be executed corresponding to a specific touch input method. Like this, a user manually sets his/her desired function so that frequently used functions can be executed by a single input, thereby making the electronic apparatus be more convenient for a user.

If a user can manually set a function to be executed corresponding to a specific touch input method, the controller 403 needs to determine whether a user's input in the current button is to set or select the function or selecting the function. As an example of distinguishing between the function setting instruction and the function selecting instruction, there are determination methods based on (1) a duration of the touch input (e.g., the function executing instruction is issued when the touch input lasts for 1-2 seconds, and the function setting instruction is issued when the touch input lasts for 3 or more seconds), (2) a number of successive touches of the user touch input (e.g., the function executing instruction is issued by successive double taps, and the function setting instruction is issued by successive triple taps; The determination based on the number of successive touches will be useful for the visually impaired, who may distinguish between the buttons through tactility by touching the buttons, rather than that based on the duration of the touch input), (3) a dedicated button separately provided to set the function button, in which the function setting instruction is issued when both the dedicated button and a button targeted for setting the function are simultaneously touched, (4) a function setting menus separately prepared in on screen display (OSD) of the display apparatus, etc. However, there are no limits to the determination methods as long as it is possible to distinguish between the function setting instruction and the function selecting instruction.

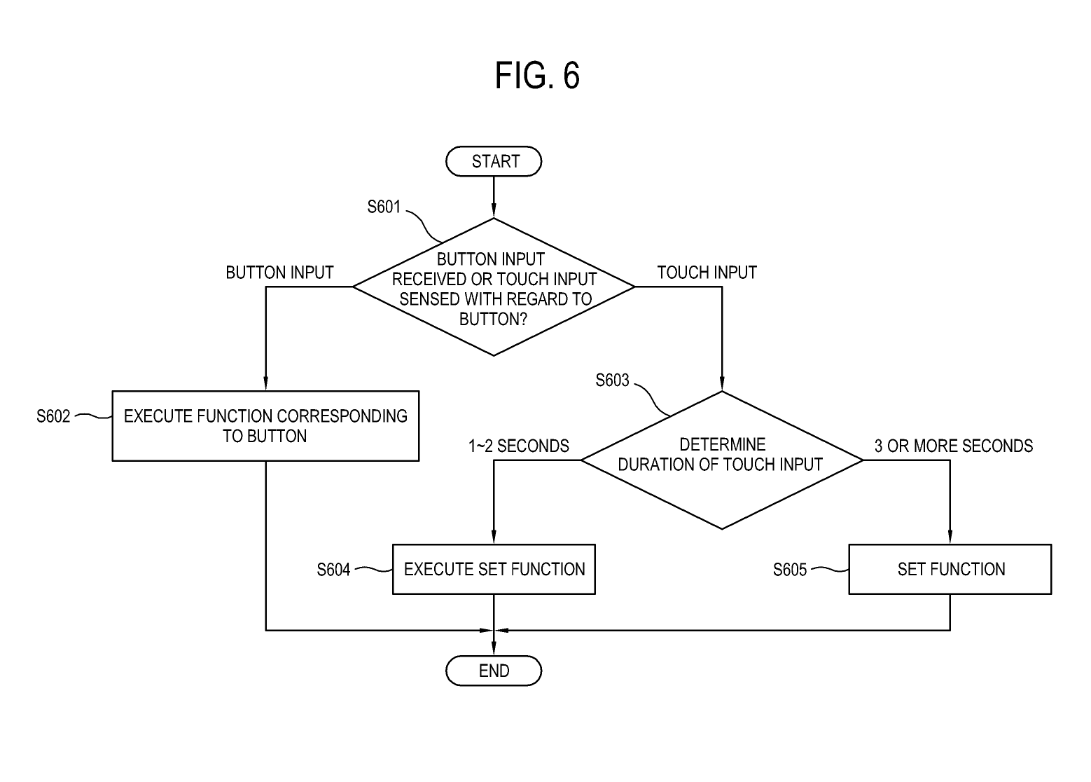

According to an exemplary embodiment, the determination method based on (1) is as follows. FIG. 6 is a flowchart of operating an electronic apparatus according to an exemplary embodiment, in which the function setting instruction and the function selecting instruction are determined based on the duration of the touch input. The button input unit 401 and the touch sensor unit 402 respectively sense the button input and the touch input of a user (S601). If a user's button input is sensed, the controller 403 executes the first function corresponding to the button among the plurality of functions provided by the display apparatus (S602). On the other hand, if a user's touch input is sensed, the controller 403 determines the duration of the touch input (S603). If the touch input lasts for, for example, 1-2 seconds, the controller 403 determines that the user's touch input is to issue the “function executing” instruction, and thus executes the second function set to the button (S604). If the touch input lasts for 3 or more seconds, the controller 430 determines that the user's touch input is to issue the “function setting” instruction and allows a user to select the second function to be set to the button (S605). Although 1-2 seconds and 3 or more seconds are respectively used in FIG. 6 for illustrative purposes, other threshold values may be used for the exemplary method illustrated in FIG. 6 or other methods disclosed herein.

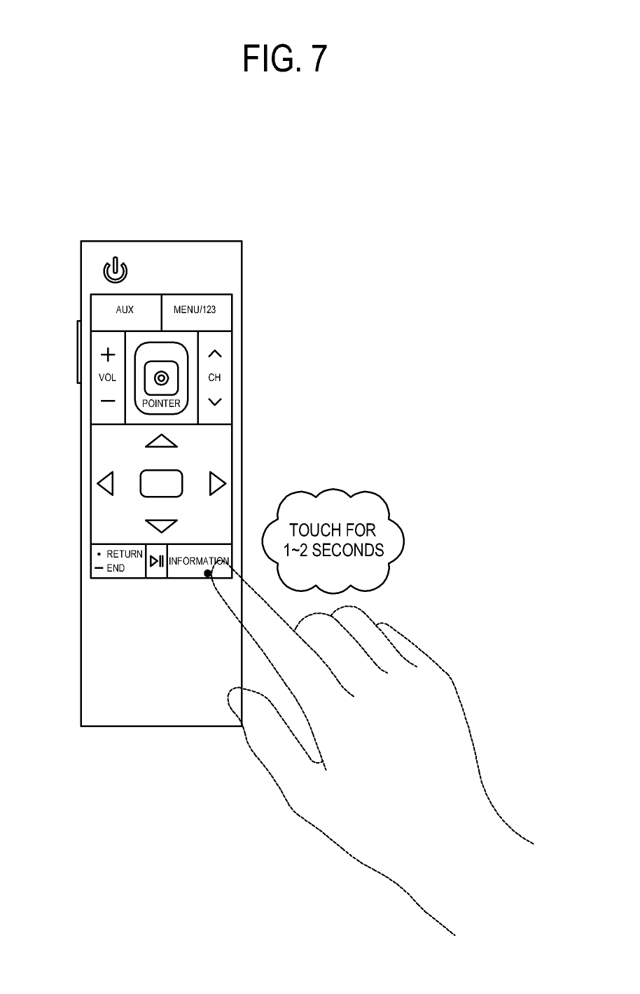

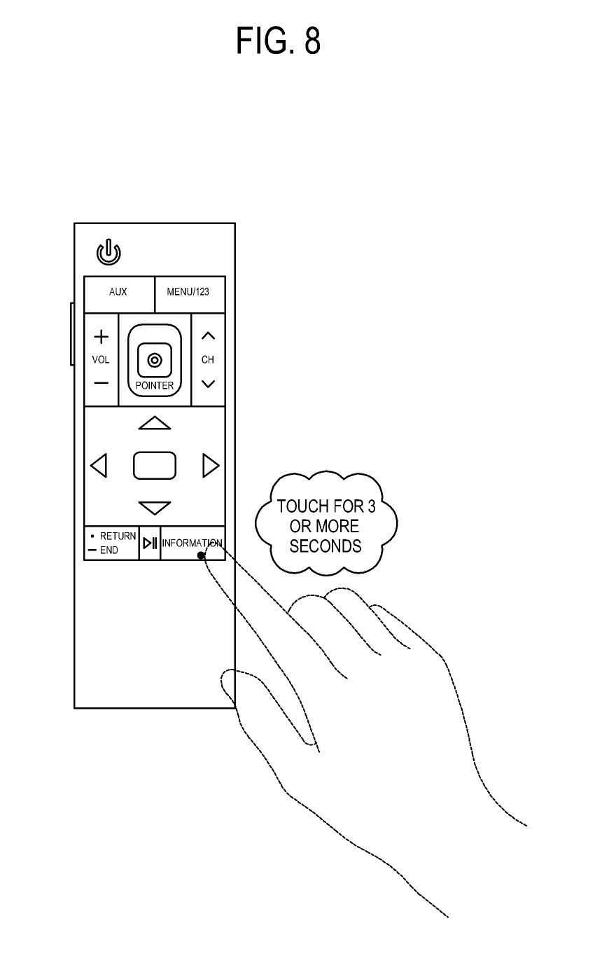

For example, if a user presses the power button under the conditions that the power on/off function is executed when the power button of the remote control is pressed and the voice guide function is executed when the power button is touched for 1-2 seconds, the button input unit 401 senses the press and sends the controller 403 a signal corresponding to a power-button press input, and the controller 403 determines that the power on/off function corresponds to the power button and controls the display apparatus to execute the power on/off function. If a user touches the power button, the touch sensor unit 402 senses the touch and sends the controller 403 a signal corresponding to the power-button touch input, and the controller determines the duration of the touch input (S603). As shown in FIG. 7, if the touch input lasts for 1-2 seconds, the controller determines that the user's input is to issue the “function executing” instruction and controls the apparatus to execute the “voice guide” function set to the power button. On the other hand, as shown in FIG. 8, if the touch input lasts for 3 or more seconds, the controller determines that the user's input is to issue the “function setting” instruction and controls the apparatus to execute a function setting mode.

The function setting mode may be achieved variously. In the function setting mode, the apparatus may, for example, inform a user of a list of selectable functions through audio output and then allow a user to select a specific function among them through a voice or button input. Further, if the apparatus includes a display, the list of selectable functions may, for example, be displayed on the display so that a user can select a specific function among the selectable functions through a voice or button input.

If a user sets the “descriptive video service” function instead of the existing “voice guide” function with regard to the power button through the function setting mode, then instead of the ‘voice guide’ function, the newly set “descriptive video service” function is executed when a user touches the power button for 1-2 seconds.

A user can manually set not only a function to be executed corresponding to a specific touch input method but also the type of touch input method. Therefore, a user can manually set what function will be executed in response to a certain touch input. For example, a user can not only select a function assigned to a button in the function setting mode but also set the method of the user touch input corresponding to the function, but not limited thereto. Through the foregoing setting method, it may be for example set to execute the voice guide function when the power button is tapped once, the descriptive video service function when the power button is tapped twice, and a screen enlarging function at lengthwise sliding.

Like this, if a user is allowed to manually set not only the function to be executed corresponding to the touch input method but also the touch input method for executing the function, it is possible to provide an input method more intuitive for the user and it is thus possible to give greater convenience and satisfaction to the user in light of a user interface.

As discussed above, if a user manually sets not only a function to be assigned to a specific button but also a user touch input method corresponding to each function, such manual setting will be called “customization” of the input method. This customized setting information may be stored in the electronic apparatus or received from an external device. For example, the information about settings customized according to users is stored in an external server, and each user accesses the external server by inputting his/her own account information and then receives the information about the customized settings. The external server may be given in the form of a cloud service. In this manner, if the customized settings are stored in the external server and then a user downloads the customized settings as necessary in the future to control the electronic apparatus, the user can control the electronic apparatus based on the settings as desired by him/her at anytime and anywhere.

In the foregoing, the function to be executed when the button is pressed is previously set regardless of the button input methods. However, because there are many button input methods (e.g., single press, double press, pressing and holding, etc.), as in the case of the touch input, one among the plural functions may be determined and then executed when the button input is sensed. In this case, the number of functions assigned to one button increases as the input methods are diversifying.

As described above, according to an exemplary embodiment, a plurality of functions may be set to buttons, which constitute a user instruction input of an electronic apparatus, and thus a user can select one among many functions by just controlling one button through a button input or a touch input. Accordingly, it is more convenient for a user to control the electronic apparatus with an input having fewer buttons.

Further, a user is allowed to directly set functions corresponding to buttons, so that the input can be customized by the user and the function frequently used by the user can be executed by a single input instruction.

Although a few exemplary embodiments have been shown and described, it will be appreciated by a person having an ordinary skill in the art that various changes and modifications may be made in these exemplary embodiments. For example, the foregoing results may be properly achieved even though the described operations may be performed in different order, or the described system, structure, device, circuit or the like elements may be differently coupled, combined or replaced or exchanged with other elements or equivalents. Therefore, it will be understood that the present inventive concept is not limited to the foregoing exemplary embodiments and the accompanying drawings, and other achievements, other embodiments and equivalents belong to the appended claims. Further, the present disclosure is not construed as limiting the present inventive concept but provided for illustrative purposes.

What is claimed is:

1. An electronic apparatus comprising:
a button input receiver comprising a button for receiving a user button input;
a touch sensor configured to sense a user touch input to the button; and
a controller configured to:
execute a first function corresponding to the button among a plurality of functions provided by the electronic apparatus in response to the user button input being received with regard to the button, and
in response to the user touch input being sensed with regard to the button, determine a second function among the plurality of functions based on a method of the user touch input and execute the determined second function.

2. The electronic apparatus according to claim 1, further comprising:
a remote control comprising the button input receiver, the touch sensor, and a transmitter for remotely transmitting a signal corresponding to the user button input or the user touch input, and
a receiver configured to receive the signal from the transmitter.

3. The electronic apparatus according to claim 1, wherein the controller is further configured to set a method of the user touch input with regard to the button, and a function corresponding to the method in accordance with a user setting input.

4. The electronic apparatus according to claim 3, wherein the controller is further configured to determine whether to set the function to the button based on a duration of the user touch input.

5. The electronic apparatus according to claim 3, wherein the controller is further configured to determine whether to set the function to the button based on a number of successive touches of the user touch input.

6. The electronic apparatus according to claim 3, further comprising a storage configured to store information about the function set to the button and the method of the user touch input corresponding to the function.

7. The electronic apparatus according to claim 3, further comprising a communicator configured to communicate with an external device,
wherein the controller is further configured to receive information about the function set to the button and the method of the user touch input corresponding to the function from the external device through the communicator.

8. The electronic apparatus according to claim 1, wherein the controller is further configured to determine the first function based on the method of the user button input and execute the determined first function.

9. A control method of an electronic apparatus, the control method comprising:
executing a first function corresponding to a button among a plurality of functions provided by the electronic apparatus in response to receiving a user button input with regard to the button; and
in response to a user touch input being sensed with regard to the button, determining a second function among the plurality of functions based on a method of the user touch input, and executing the determined second function.

10. The control method according to claim 9, further comprising transmitting, from a remote control device to the electronic apparatus, a signal corresponding to the user button input or the user touch input with regard to the button.

11. The control method according to claim 9, further comprising setting the method of the user touch input with regard to the button, and a function corresponding to the method in accordance with a user setting input.

12. The control method according to claim 11, further comprising determining whether to set a function to the button based on a duration of the user touch input.

13. The control method according to claim 11, further comprising: determining whether to set a function to the button based on a number of successive touches of the user touch input.

14. The control method according to claim 11, further comprising storing information about the function set to the button and the method of the user touch input corresponding to the function.

15. The control method according to claim 11, further comprising receiving information about the function set to the button and the method of the user touch input corresponding to the function from an external device.

16. The control method according to claim 9, further comprising determining first function based on the method of the user button input, and executing the determined first function.
